(19) United States
(12) Patent Application Publication
(10) Pub. No.: US 2005/0076620 A1
(43) Pub. Date: Apr. 14, 2005

(54) Safety stirrup with detachable elastic portion

(76) Inventor: Rolf Sjosward, Vallda (SE)

Correspondence Address: HARNESS, DICKEY & PIERCE, P.L.C., P.O. BOX 8910, RESTON, VA, 20195, US

(21) Appl. No.: 10/928,207

(22) Filed: Aug. 30, 2004

(30) Foreign Application Priority Data
Sep. 15, 2003 (SE) 0302454-4

(51) Int. Cl. B68C 3/00

(52) U.S. Cl. 54/48

(57) ABSTRACT

A stirrup (1) which comprises a base part (2) and stirrup arms (3, 4), for use while riding, the stirrup arm (3) which in use is the outer arm, seen from the horse, being elastic at least along a portion (6). The elastic portion (6) is arranged on the outer stirrup arm (3) in such a manner that the elastic portion (6) is detachable along the extent of the outer stirrup arm (3) at least at one end of the elastic portion (6).

### FIELD OF THE INVENTION

The present invention relates to a stirrup, comprising a base part and stirrup arms, for use while riding, the stirrup arm which in use is the outer arm, seen from the horse, being elastic at least along a portion.

### BACKGROUND ART

Stirrups as described above are available on the market, in which the elastic portion is a rubber ring. The rubber ring is stretched along one side of the stirrup so as to extend between one end of the base part and a hook arranged in connection with the attachment for the stirrup leather in the stirrup. The idea of this type of solution is that the rubber ring is to be stretched out or slide off the hook when the rider is thrown off or in some other manner falls off a horse, so that his foot does not become trapped with the horse running if it comes to the worst. A problem with this type of stirrup, however, is that there is no support for the foot in the direction in the stirrup where this rubber ring is arranged. When moving the foot vigorously in the stirrup there is no support and, thus, the rubber ring can unintentionally slide off the hook.

On the market there are many other stirrups that are adapted to release the rider's feet when falling off the horse. Most of these stirrups comprise different kinds of more or less advanced functions that are not always reliable. As a result of many parts being articulated to each other there is a risk of such joints jamming if, for instance, earth or clay sticks to the stirrup, which frequently happens especially where the ground is wet as the rider mounts his horse. The more complicated such constructions, the more expensive they are as a rule.

### SUMMARY OF THE INVENTION

The object of the present invention therefore is to provide a stirrup which obviates the above problems.

According to the invention, this object is achieved by the stirrup of the type stated by way of introduction being given the features that are evident from claim 1. Preferred embodiments of the stirrup will be defined by the dependent claims.

The inventive stirrup comprises a base part and stirrup arms, for use while riding, the stirrup arm which in use is the outer arm, seen from the horse, being elastic at least along a portion. Furthermore, the elastic portion is arranged on the outer stirrup arm in such a manner that the elastic portion is detachable along the extent of the outer stirrup arm at least at one end of the elastic portion. The elastic portion and the remaining part of the outer stirrup arm are thus disconnectible when the elastic portion is subjected to tractive force, relative to the extension of the stirrup arm, exceeding a certain threshold value. The above-mentioned tractive force arises in use by the rider's foot applying a pressure to the side of the elastic portion which thus is pulled out of its position, i.e. out of the connection to the remaining part of the stirrup arm. A great advantage of this solution thus is that the elastic portion is only pulled out of its position and, thus, can be put back again.

Preferably the elastic portion and the remaining part of the outer stirrup arm are arranged adjacent to each other with female and male couplings. This type of coupling is well suited when taking-apart is to occur in the axial direction while at the same time the coupling should withstand loads perpendicular to the coupling.

The ends of the elastic portion preferably constitute the female coupling parts and the elastic portion is suitably made of rubber. In terms of manufacture, this is a great advantage since a standard size rubber tube can be used and, thus, no special part has to be manufactured. The only working that is necessary consequently is a cutting operation to obtain the correct length of the tube. Moreover, the male parts preferably consist of parts on the remaining part of the stirrup arm, which parts are of a size fitting the inner diameter of the tube. Preferably the male part extending up from the base part is made long enough to be able to constitute a lateral support to the sole of the riding boot.

Conveniently the elastic portion is arched when positioned in the stirrup, i.e. it constitutes a fairly large part of the stirrup arm. As a result of the arched shape, the elastic portion offers resistance to being bent towards the rider's foot and is consequently easier to be bent outwards. This thus protects the foot from being subjected to loads from the outside, and at the same time the foot can more easily leave the stirrup when the elastic portion is “prebent” away from the stirrup.

The base part of the stirrup is preferably angled relative to the stirrup arms in such a manner that, in use, it guides the rider's foot to a position where the heel is located at a slightly lower level compared to the front part of the foot. This requires, of course, the base part to have a certain extent in the longitudinal direction of the foot. Such angling helps especially beginners to obtain a correct riding posture and at the same time it adds to the comfort of experienced riders since they can use the entire base part for the foot to rest on instead of the sole being in contact only with the rear edge of the stirrup, especially when boots with a rigid sole is used.

Moreover the base part is suitably frame-shaped, i.e. it is hollow seen from above and from below. This saves material, but also allows in an easy way a rubber pad to be fixed to the base part. The rubber pad or tread is suitably made of a material that produces high friction against the sole of the rider's boot. The higher friction, the better control of the location of the stirrup relative to the rider's foot.

The rubber pad preferably has recesses for the stirrup arms to be able to cover the entire base part.

### BRIEF DESCRIPTION OF THE FIGURES

The invention will now be described in more detail by way of embodiments with reference to the accompanying Figures.

FIG. 1 is a perspective view of a preferred embodiment of a stirrup according to the present invention.

FIGS. 2a, 2b and 2c show a sequence of the function of the stirrup during opening.

FIG. 3 is a perspective view of the stirrup in FIG. 1, without the elastic portion.

FIG. 4 is a side view of the stirrup suspended from a stirrup leather.

### DESCRIPTION OF PREFERRED EMBODIMENTS

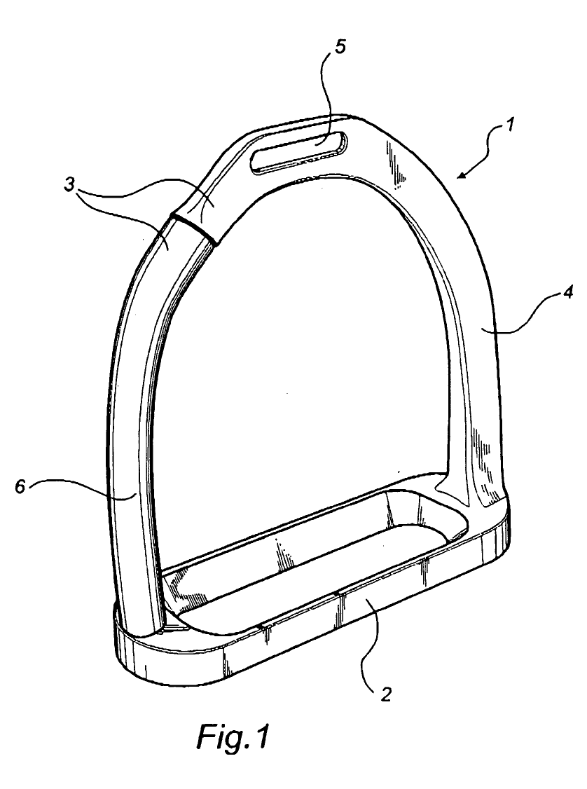

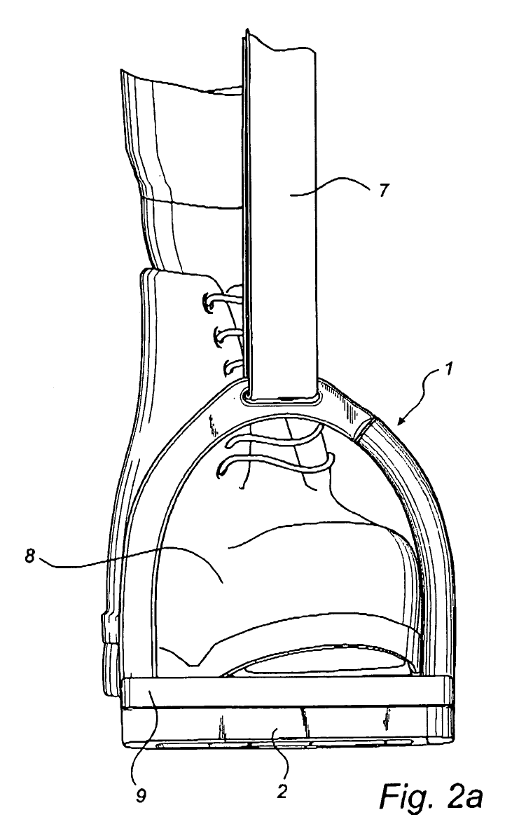

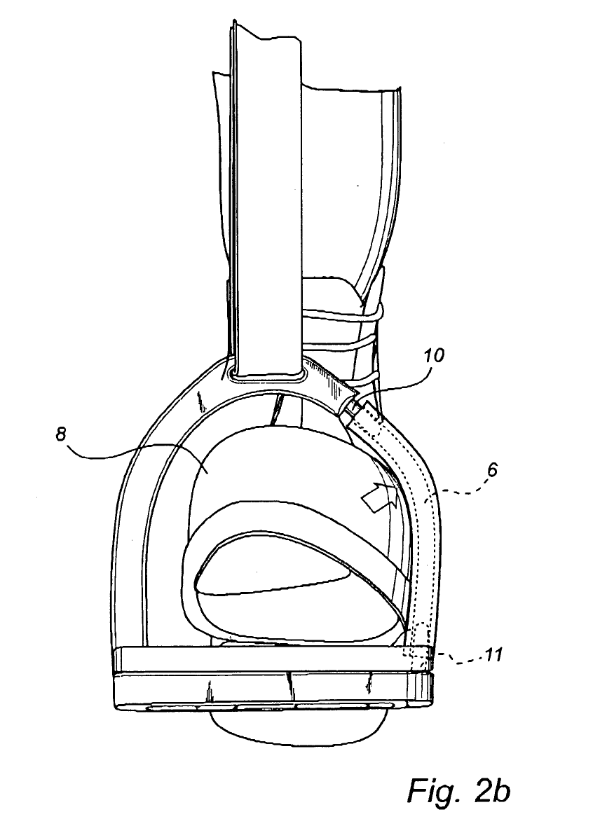

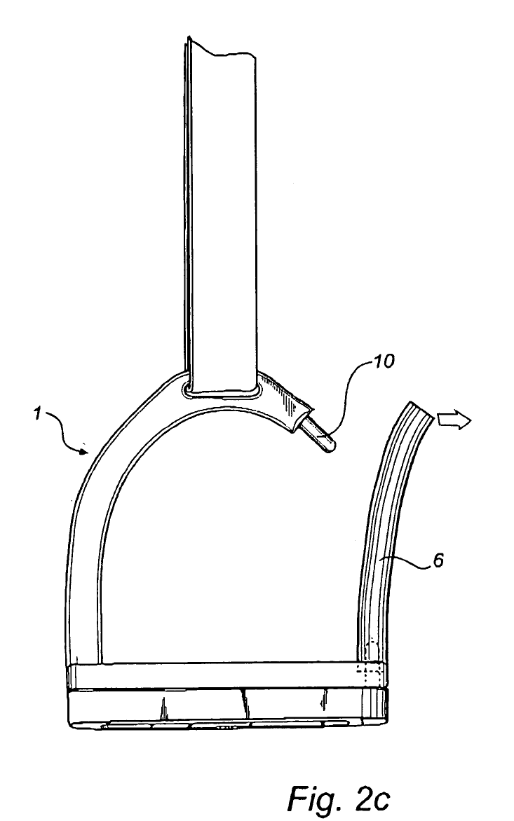

The stirrup 1 in FIG. 1 comprises a base part 2 and two stirrup arms 3, 4 and also an opening 5 by which the stirrup 1 is suspended from a stirrup leather 7 (see FIG. 2a). One stirrup arm 3 has an elastic portion 6, preferably a rubber tube. The stirrup 1, except the elastic portion 6, is preferably made of steel.

FIG. 2a shows the stirrup 1 in use suspended from a stirrup leather 7, a rider's foot 8 being inserted in the stirrup 1. A rubber pad 9 is arranged adjacent to the base part 2 in order to, for instance, increase friction between the riding boot and the stirrup. Increased friction results in increased control of the position of the foot relative to the stirrup. FIG. 2b illustrates how the elastic portion 6 begins to slide off the male parts 10, 11 when a pressure is applied by the foot 8 to the side of the elastic portion 6. FIG. 2c shows the stirrup 1 when the foot has been released from the stirrup and the upper end of the elastic portion 6 has come loose from the upper male part 10 of the stirrup 1. When re-arranging the stirrup, the elastic portion 6 is bent and the tube 6 is fitted onto the male part 10 again.

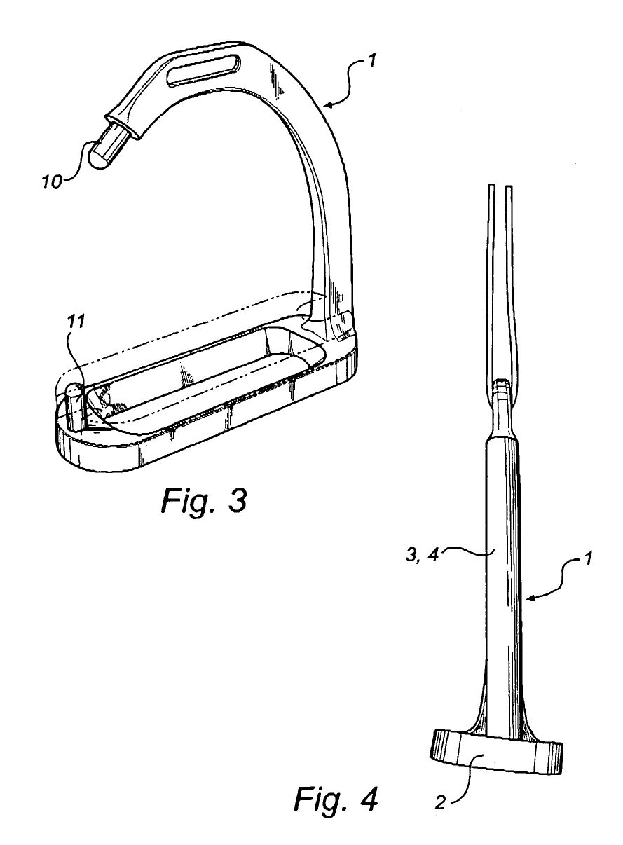

The stirrup 1 without the elastic portion is shown in FIG. 3, in which the design of the male parts 10, 11 is to be seen more distinctly.

FIG. 4 is a side view of a preferred embodiment of the stirrup 1 according to the present invention. In this embodiment, the stirrup arms 3, 4 are not quite perpendicular to the base part 2. The advantage of such angling is that it makes it easier for the rider to obtain a correct angle of his feet relative to the stirrup 1, i.e. so that the front part of his foot will naturally have a slightly higher position than the rear part.

It will be appreciated that many modifications of the above-described embodiments of the invention are conceivable within the scope of the invention as defined by the appended claims. For example, as described above the ends of the elastic portion may constitute the male parts and the coupling parts on the remaining stirrup may constitute the female parts. It is also possible to articulate one or both male parts to the remaining stirrup in such a manner that the male parts can pivot away from the stirrup. This would aid the release of the stirrup. To prevent the male part or parts from pivoting too easily, the joint is preferably provided with some type of spring assembly which strives to hold the male part or parts in the original position. Moreover, the elastic portion may consist of some other material than rubber, for instance, some plastic. It goes without saying that the same applies also to the “rubber” pad adjacent to the base part of the stirrup. The stirrup can also be made of some other metal than steel, such as aluminium or titanium, or alternatively some other material, such as carbon fibre or Kevlar. It is also possible to make the stirrup in such a manner that one and the same stirrup is made of different materials.

1. A stirrup comprising a base part and stirrup arms for use while riding, the stirrup arm which in use is the outer arm, seen from the horse, being elastic at least along a portion wherein the elastic portion is arranged on the outer stirrup arm in such a manner that the elastic portion is detachable along the extent of the outer stirrup arm at least at one end of the elastic portion the elastic portion and the remaining part of the outer stirrup arm being arranged adjacent to each other with female and male couplings.

2. A stirrup as claimed in claim 1, in which both ends of the elastic portion constitute female coupling parts.

3. A stirrup as claimed in claim 2, in which the elastic portion is a rubber tube.

4. A stirrup as claimed in claim 1, in which the elastic portion is arched when arranged adjacent to the stirrup.

5. A stirrup as claimed in claim 1, in which the base part is angled relative to the stirrup arms in such a manner that, in use, it guides the rider's foot to a position where the heel is positioned at a slightly lower level compared to the front part of the foot.

6. A stirrup as claimed in claim 1, in which the base part is frame-shaped.

7. A stirrup as claimed in claim 1, in which a rubber pad is arranged adjacent to the base part.

8. A stirrup as claimed in claim 6, in which the lower part of the rubber pad is shaped so as to be able engage the frame of the base part.

9. A stirrup as claimed in claim 7, in 10 which the rubber pad has recesses for the stirrup arms.
